(19) United States
(12) Patent Application Publication
(10) Pub. No.: US 2019/0057591 A1
(43) Pub. Date: Feb. 21, 2019

(54) Emergency Message Alert System

(71) Applicant: Andy K. F. Kaoh, Costa Mesa, CA (US)

(72) Inventor: Andy K. F. Kaoh, Costa Mesa, CA (US)

(21) Appl. No.: 16/020,693

(22) Filed: Jun. 27, 2018

Related U.S. Application Data
(60) Provisional application No. 62/525,978, filed on Jun. 28, 2017.

(51) Int. Cl. G08B 21/02; G08B 5/38

(52) U.S. Cl. CPC G08B 21/02; G08B 17/08; G08B 5/38

(57) ABSTRACT

An Emergency Message Alert System is disclosed. The Emergency Message Alert System may be attached to a television that is placed in a public place such as in an airport. The Emergency Message Alert System monitors television broadcasts and other sources for emergencies that may affect the local area. When the Emergency Message Alert System detects an emergency that affects the nearby area, the system becomes activated and will alert people that an emergency is occurring by displaying a message or flashing LEDs on a front display. When activated, this system will direct the people to watch the information being presented on the accompanying television monitor.

### RELATED APPLICATION INFORMATION

The present application claims priority under 35 U.S.C. Section 119(e) to U.S. Provisional Patent Application Ser. No. 62/525,978 filed Jun. 28, 2017 entitled “Emergency Message Alert System” the disclosure of which is incorporated herein by reference in its entirety.

### BACKGROUND OF THE INVENTION

### 1. Field of the Invention

The present invention relates in general to displays. In particular, the invention is directed to a display for providing emergency messages.

### 2. Description of the Related Art

Governments and other agencies rely on television broadcasts to inform the public of emergencies or other disasters. Conventionally, when an emergency alert is broadcasted on a television display, many people may not realize that an emergency has occurred and may erroneous believe the broadcast was part of the television program. This may be particularly important for television monitors that are placed in public areas such as in airports, as many may ignore an emergency alert.

Accordingly, a need exists to provide a device for alerting people of a pending emergency.

### SUMMARY OF THE INVENTION

In the first aspect, an emergency message alert system is disclosed. The emergency message alert system comprises a communication device receiving notification of an emergency, a controller coupled to the communication device, and one or more display devices for providing indicia of the emergency.

In a first preferred embodiment, the emergency alert system is configured to attach to a monitor. The communication device is preferably communicating with the Emergency Alert System. The communication device is preferably communicating with a television monitor. The one or more display devices preferably comprises one or more strobe lights and an electronic visual display. The electronic visual display preferably comprises a segmented Light Emitting Diode (“LED”) display. The emergency message alert system preferably further comprises a microphone for monitoring audio of an environment, a camera for visually monitoring the environment, and a speaker for addressing the environment. The controller is preferably configured to analyze the audio of the environment, determine if an emergency has occurred, generate an emergency alert signal, and transmit the emergency alert signal to a remote location. The emergency alert signal preferably comprises an image obtained by the camera.

In a second aspect, an emergency message alert system is disclosed. The emergency message alert system comprises an I/O (“input/output”) device for communicating notifications of an emergency, the I/O device comprises a one or more communication channels, a controller coupled to the I/O device, the controller continuously monitoring the notifications of the emergency, and one or more display devices for providing indicia of the emergency, the display comprising at least one strobe light and an electronic visual display.

In a second preferred embodiment, the emergency alert system is configured to attach to a monitor.

In a third aspect, a method for providing emergency message alerts is disclosed. The method comprises providing an emergency message alert system comprising a communication device, a controller coupled to the communication device, and one or more display devices, continuously monitoring for a notification of an emergency, detecting the notification of the emergency, and providing an indication of emergency.

In a third preferred embodiment, the emergency message alert system further comprises one or more strobe lights and an electronic visual display, wherein providing an indication of the emergency comprises illuminating the one or more strobe lights and providing a message on the electronic visual display. Continuously monitoring preferably comprises monitoring a television broadcast for emergency messages. Continuously monitoring preferably comprises monitoring a government emergency alert system for emergency messages. The method preferably further comprises activating the emergency alert system, monitoring for the notification of the termination of an emergency, and deactivating the emergency alert.

The emergency message alert system preferably further comprises a microphone for monitoring audio of an environment, a camera for visually monitoring the environment, and a speaker for addressing the environment. The method preferably further comprises analyzing the audio of the environment by the controller, determining if an emergency has occurred, generating an emergency alert signal, and transmitting the emergency alert signal to a remote location. The emergency alert signal preferably comprises an image obtained by the camera. Analyzing the audio of the environment preferably comprises analyzing the audio to sense a gun was shot.

These and other features and advantages of the invention will become more apparent with a description of preferred embodiments in reference to the associated drawings.

### DESCRIPTION OF THE DRAWINGS

FIG. 1 is a front view of an Emergency Message Alert System.

FIG. 2 is a front view of the Emergency Message Alert System attached to a television.

FIG. 3 is a front view of an Emergency Message Alert System employing a plurality of 16 segment LED displays.

FIG. 4 is a front view of an Emergency Message Alert System employing a matrix of LEDs.

FIG. 5 is a front view of an Emergency Message Alert System employing a display screen.

FIG. 6 is a back view of an Emergency Message Alert System.

FIG. 7 is a schematic, block diagram of the Emergency Message Alert System.

FIG. 8 is a flowchart illustrating an exemplary method of the Emergency Message Alert System.

FIG. 9 is a flowchart illustrating an exemplary method of the Emergency Message Alert System switching between active and dormant states.

### DETAILED DESCRIPTION OF THE PREFERRED EMBODIMENTS

In one or more embodiments, an emergency message alert system having an illuminated display is attached to an accompanying television, which may be placed in a public place such as an airport for example. The emergency message alert system monitors whether an emergency broadcast is being presented on the accompanying television. The emergency message alert system is usually in a dormant state such that the display is not illuminated. However, when the system detects that television monitor is reporting an emergency, the emergency message alert system becomes activated and will alert people that an emergency is occurring by displaying a message or flashing LEDs. When activated, this system will direct the people to watch the information being presented on the accompanying television monitor.

In an embodiment, the emergency message alert system may further comprise one or more strobe lights which illuminate or may flash when an emergency broadcast message has been detected. In an embodiment, the emergency message alert system may also be configured to monitor other sources of information such as the US government Emergency Broadcast System or Emergency Alert System to determine if an emergency event has occurred.

One or more embodiments comprises a strip of LED lights, similar to that of a Police car except smaller and maybe having only red flashing lights for emergency alerting purposes. Embodiments will alert people that an emergency is occurring and that important information is being presented on the television monitor such as an LCD television.

One or more embodiments comprises an LED strip, approximately 2″ high×12″ long for example. The system may appear wide looking from the front that would flash with strobes on both ends and at the middle show something like “Emergency Alert!” The sign will be clipped on top of the monitor. The alert system may be painted red in an embodiment.

As used herein and as is commonly known in the art, the term “electronic visual display” is a display device for the presentation of images, text, or video and may include such devices as LED, OLED, or LCD (Liquid Crystal Devices”) in the form of segmented displays, matrix displays panel displays for example.

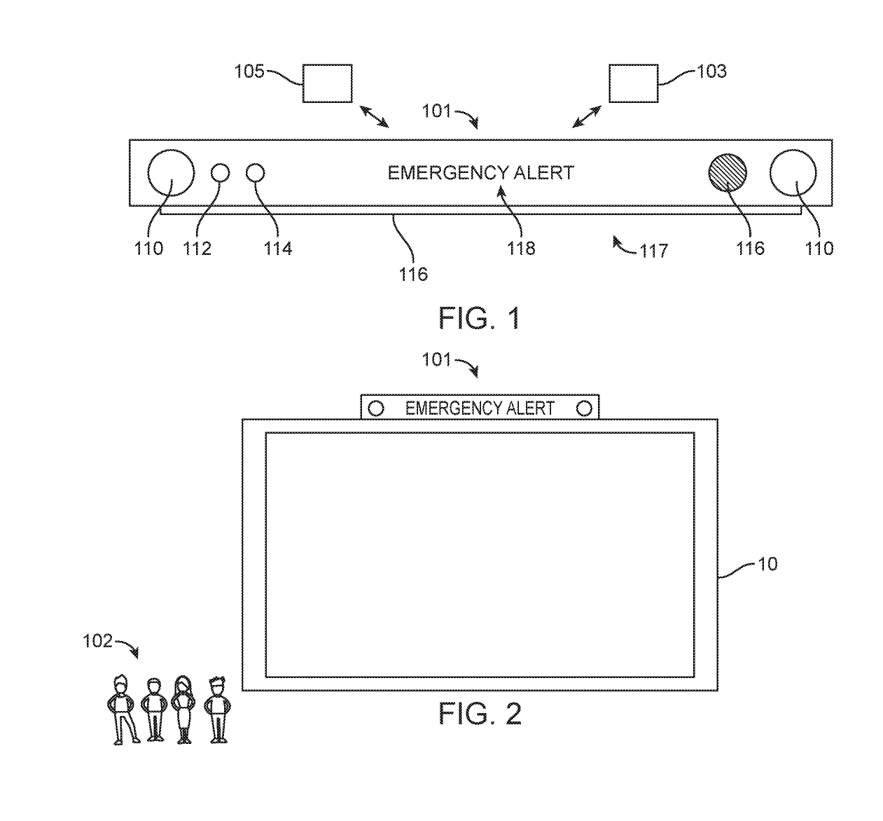

FIG. 1 is a front view of an Emergency Message Alert System 101 (“system” hereafter). In an embodiment, the system 101 comprises one or more display devices 117 which may include a display message on a display device 118, and one or more strobe lights 110. The system 101 may have a clip mechanism 116 for attaching to a television monitor 10 (see FIG. 2). In an embodiment, the system 101 further comprises a camera 112 for visually monitoring the environment 102 near the system 101, a microphone 114 for monitoring the audio or sounds from the environment 102, and a speaker or loudspeaker 116 for communicating with the environment 102.

In one or more embodiments, the system 101 is in communication with one or more emergency information sources 105 which may include public or private agencies, or may include government agencies such as the Emergency Alert System formally known as the Emergency Broadcast System. Other information sources 105 may include television or radio broadcasts, and internet sources.

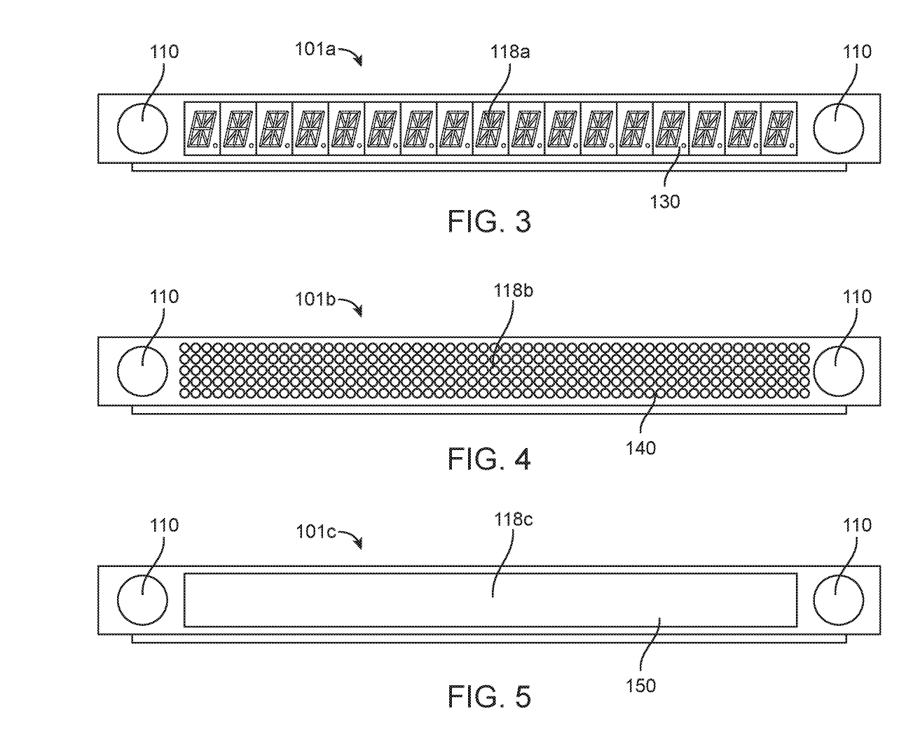

When activated, the message “EMERGENCY ALERT” 118 may be illuminated, and the strobe lights 110 will be illuminated. The display may be comprised of a plurality of discrete or segmented LEDs (“Light Emitting Diodes”) (see 118a FIG. 3), or may comprise a graphic overlay placed over a light source. The clip mechanism 116 is configured to attach the system to a television monitor.

In an environment, the Emergency Message Alert System 101 may monitor local environment 102 and communicate to a remote location 103 or office. In an embodiment, a Security office 103 can hear the local environment 102 such as a classroom may detect if there was a gun shot was detected by the microphone 114. The camera 112 will be turned on and the system 101 will send an image or picture to the security office 103.

FIG. 2 is a front view of the Emergency Message Alert System 101 attached to a monitor 10 or television. In an embodiment, the system 101 is attached to the top surface of a television monitor 10, although the system could be placed elsewhere near the television monitor.

FIG. 3 is a front view of an Emergency Message Alert System 101a employing a plurality of segmented LED displays 118a, in this case a plurality of 16 segmented LED displays. FIG. 4 is a front view of an Emergency Message Alert System 101b employing a matrix of LEDs 118b. In an embodiment, a predetermined, generic message may be displayed such as “EMERGENCY ALERT!” for example. In a preferred embodiment, the system 101b can generate specific messages to the public, such as “TORNADO ALERT” or “EARTHQUAKE” for example. The system 101b may be configured to provide a scrolling or “news ticker” message, enabling longer messages to be provided to the public.

FIG. 5 is a front view of an Emergency Message Alert System 101c employing a display screen 118c. While reference is made herein to displays comprising LEDS, it shall be understood that other displays such as LCD, electroluminescent displays, OLEDs, and plasma displays are contemplated in one or more embodiments.

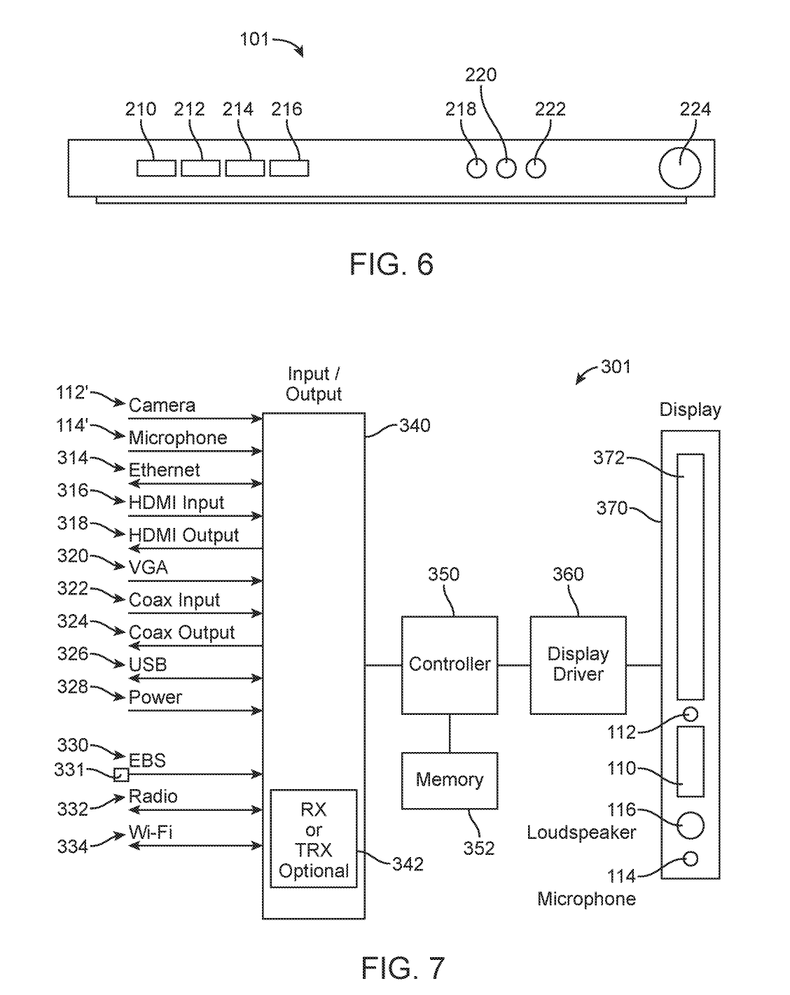

FIG. 6 is a back view of an Emergency Message Alert System 101. On the back side, embodiments may have one or more of the following: an Ethernet connection 210, a HDMI Input 212 (input from other Media device), and HDMI Output 214 (“High-Definition Multimedia Interface,” output to LCD monitor), a USB port 216 (“Universal Serial Bus,” input Media device, Media is on USB Memory), a Coaxial Input 218, a Coaxial Output 220, a VGA connection 222 (“Video Graphics Array,” Input from other Media Device), and a Power Input 224. Embodiments may also have a coaxial input from other Media sources. Some locations already using broadcasting like coaxial cable like the old satellite receivers. Embodiments would take that signal and directly feed the LCD monitor until there is an emergency. Embodiments may also have a coaxial output—output to LCD. When there is no emergency, the input signal from Coaxial will be “bypass” to Monitor. When there is an emergency, embodiments of the emergence message alert system will intercept the cable message and send an emergency message to the LCD Monitor.

FIG. 7 is a schematic, block diagram of the Emergency Message Alert System 301 comprising an I/O device (“input/output”) 340 or devices, a controller 350, memory 352, a display driver 360, and one or more display devices 370 in an embodiment. The I/O device 340 may support a connection 112′ to a camera 112, a connection 114′ to a microphone 114, an Ethernet connection 314, an HDMI Input 316 connection, an HDMI Output connection 318, a Coax Input connection 322, a Coax Output connection 324, a USB connection 326, a power connection 328, an EBS connection 330 which connects to the Emergency Alert System 331 or Emergency Broadcast System, a radio connection 332, and Wi-Fi connection 334.

The controller 350 may comprise a microprocessor, a digital signal processor, or other types of controlling devices in one or more embodiments. The controller 350 receives and transmits information via the I/O device 340, and controls the display driver 360 to display a message on the display devices 370 when appropriate. In one or more embodiments, the system may further comprise a receiver (“RX”) or a transceiver (“TRX”) 342. Embodiments may be configured to receive government emergency alerts such as the Emergency Alert System 331 or the Emergency Broadcast system.

In one or more embodiments, the system 301 may be configured to receive and transmit data using wireless local networking such as Wi-Fi. Such a system would be able to communicate via wireless access points common in many public areas such as airports. This system may be able to obtain Internet access and monitor emergency or government websites for emergency information.

In one or more embodiments, emergency message alert system 301 comprises a communication device (e.g., I/O device 340) receiving notification of an emergency, a controller 350 coupled to the communication device 340, and one or more display devices 370 for providing indicia of the emergency.

In one or more embodiments, the emergency message alert system 301 comprises an I/O (“input/output”) device 340 for communicating notifications of an emergency, the I/O device comprises a one or more communication channels (e.g., 112′, 114′, 314, 316, 318, 320, 322, 324, 326, 328, 330, 332, 334). The system 301 further comprises a controller 350 coupled to the I/O device 340, the controller 350 continuously monitoring the notifications of the emergency, and one or more display devices 370 for providing indicia of the emergency, the one or more display devices 370 comprising at least one strobe light 110 and an electronic visual display 372.

The emergency alert system 301 is configured to attach to a monitor 10. In an embodiment, the communication device 340 is communicating with the Emergency Alert System 331 or other government or private emergency alerting agencies. In an embodiment, the communication device 340 is communicating with a television monitor 10. The one or more display devices 370 comprises one or more strobe lights 110 and an electronic visual display 372. In an embodiment, the electronic visual display 372 comprises a segmented Light Emitting Diode (“LED”) display 118a.

In one or more embodiments, the emergency message alert system 301, further comprises a microphone 114 for monitoring audio of an environment 102, a camera 112 for visually monitoring the environment 102, and a speaker 116 for addressing the environment. The controller 350 is configured to analyze the audio of the environment 102, determine if an emergency has occurred, generate an emergency alert signal, and transmit the emergency alert signal to a remote location 103. In an embodiment, the emergency alert signal comprises an image obtained by the camera 112.

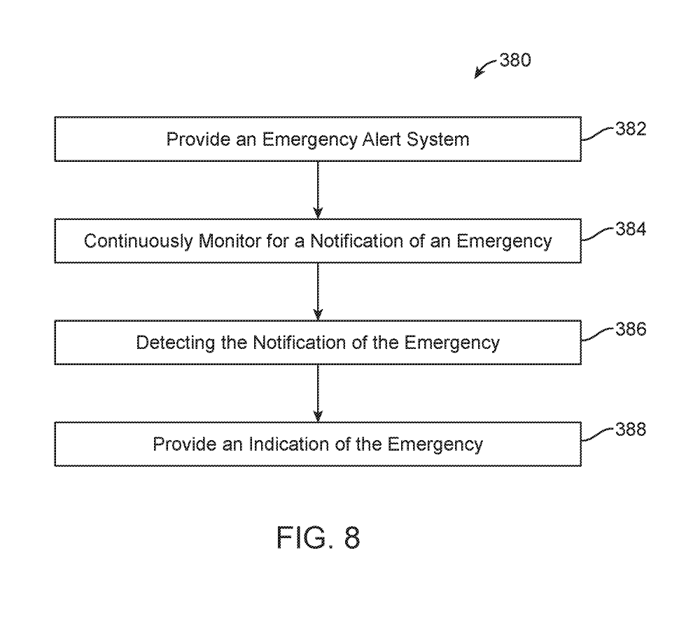

FIG. 8 is a flowchart illustrating an exemplary method 380 of the Emergency Message Alert System. The method 380 for providing an emergency message alert system comprising a communication device, a controller coupled to the communication device, and a display (step 382), continuously monitoring for a notification of an emergency (step 384), detecting the notification of the emergency (step 386), and providing an indication of emergency (step 388).

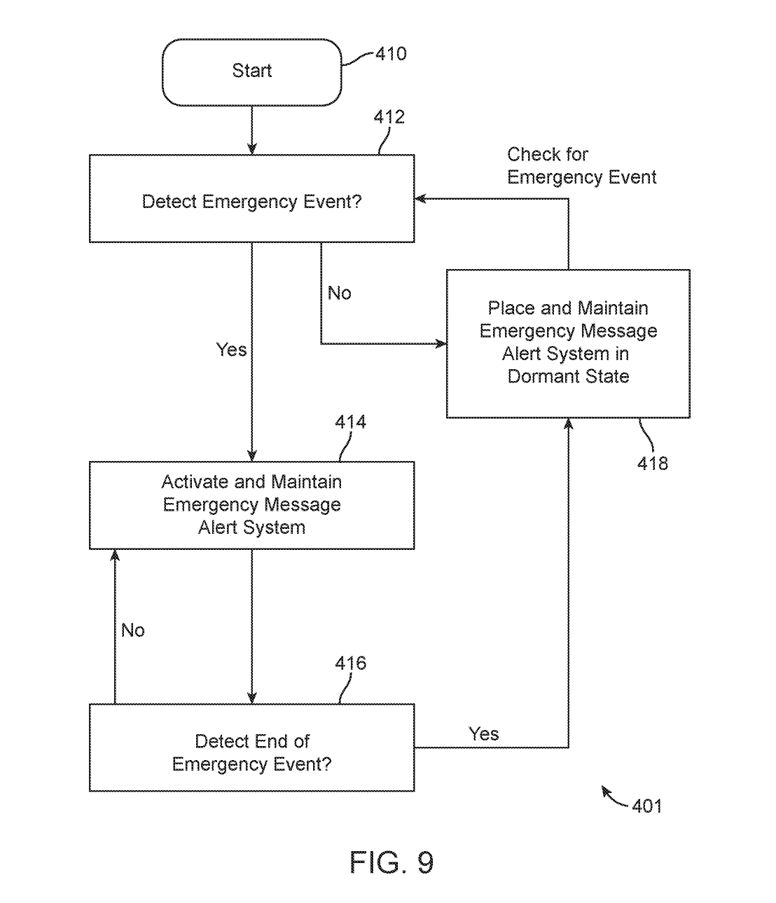

In one or more embodiments, the emergency message alert system 101 further comprises one or more strobe lights 110 and an electronic visual display 118, wherein providing an indication of the emergency comprises illuminating the one or more strobe lights 110 and providing a message on the electronic visual display 118. In an embodiment, continuously monitoring (i.e., step 384) comprises monitoring a television broadcast for emergency messages. In an embodiment, continuously monitoring (step 384) comprises monitoring a government emergency alert system 330 for emergency messages. In an embodiment, the method 380 further comprises activating the emergency alert system (see step 414, FIG. 9 below), monitoring for the notification of the termination of an emergency (step 416), and deactivating the emergency alert (step 418).

In one or more embodiments, the emergency message alert system 101 further comprises a microphone 114 for monitoring audio of an environment 102, a camera 112 for visually monitoring the environment 102, and a speaker 16 for addressing the environment 102. In an embodiment, the method 380 further comprises analyzing the audio of the environment 102 by the controller 350, determining if an emergency has occurred, generating an emergency alert signal, and transmitting the emergency alert signal to a remote location. In an embodiment, the emergency alert signal comprises an image obtained by the camera 112. In an embodiment, analyzing the audio of the environment comprises analyzing the audio to sense a gun was shot.

FIG. 9 is a flowchart illustrating an exemplary method 401 of the Emergency Message Alert System 101. The method places and maintains the system 101 into a dormant, inactivated state until such time an emergency broadcast is being presented on the television or an emergency event has been detected, which then activates the emergency message alert system. From “Start” (step 410) the system 101 determines whether emergency broadcast is being presented on the television or an emergency event has been detected (step 412). If no such broadcast is being presented on the television or no emergency event has been detected, the system is placed and maintained in a dormant state (step 418). If such broadcast is being presented on the television or an emergency event has been detected, the system is placed and maintained in an active state (step 414). From this dormant state, the system continuously monitors whether emergency broadcast is being presented on the television or an emergency event has been detected (step 416).

When an emergency broadcast is being presented on the television or an emergency event has been detected, the emergency message alert system is activated until the system determines that the emergency broadcast or event has ended, at which point the system returns to a dormant state awaiting another emergency broadcast is being presented on the television or an emergency event has been detected.

Although the invention has been discussed with reference to specific embodiments, it is apparent and should be understood that the concept can be otherwise embodied to achieve the advantages discussed. The preferred embodiments above have been described primarily as an emergency message alert system for alerting people to watch the information being displayed on an accompanying television during an emergency. . In this regard, the foregoing description of the emergency message alert system is presented for purposes of illustration and description. It shall be apparent that other media or public events would benefit from the emergency message alert system.

Furthermore, the description is not intended to limit the invention to the form disclosed herein. Accordingly, variants and modifications consistent with the following teachings, skill, and knowledge of the relevant art, are within the scope of the present invention. The embodiments described herein are further intended to explain modes known for practicing the invention disclosed herewith and to enable others skilled in the art to utilize the invention in equivalent, or alternative embodiments and with various modifications considered necessary by the particular application(s) or use(s) of the present invention.

What is claimed is:

1. An emergency message alert system, the system comprising:
a communication device receiving notification of an emergency;
a controller coupled to the communication device; and
one or more display devices for providing indicia of the emergency.

2. The emergency message alert system of claim 1, wherein the emergency alert system is configured to attach to a monitor.

3. The emergency message alert system of claim 1, wherein the communication device is communicating with the Emergency Alert System.

4. The emergency message alert system of claim 1, wherein the communication device is communicating with a television monitor.

5. The emergency message alert system of claim 1, wherein the one or more display devices comprises one or more strobe lights and an electronic visual display.

6. The emergency message alert system of claim 1, wherein the electronic visual display comprises a segmented Light Emitting Diode (“LED”) display.

7. The emergency message alert system of claim 1, further comprising:
a microphone for monitoring audio of an environment;
a camera for visually monitoring the environment; and
a speaker for addressing the environment.

8. The emergency message alert system of claim 7, wherein the controller is configured to analyze the audio of the environment, determine if an emergency has occurred, generate an emergency alert signal, and transmit the emergency alert signal to a remote location.

9. The emergency message alert system of claim 8, wherein the emergency alert signal comprises an image obtained by the camera.

10. An emergency message alert system, the system comprising:
an I/O (“input/output”) device for communicating notifications of an emergency, the I/O device comprises a one or more communication channels;
a controller coupled to the I/O device, the controller continuously monitoring the notifications of the emergency; and,
one or more display devices for providing indicia of the emergency, the display comprising at least one strobe light and an electronic visual display.

11. The emergency message alert system of claim 10, wherein the emergency alert system is configured to attach to a monitor.

12. A method for providing emergency message alerts, the method comprising:
providing an emergency message alert system comprising a communication device, a controller coupled to the communication device, and one or more display devices;
continuously monitoring for a notification of an emergency;
detecting the notification of the emergency; and,
providing an indication of emergency.

13. The method for providing emergency message alerts of claim 12, wherein the emergency message alert system further comprises one or more strobe lights and an electronic visual display, wherein providing an indication of the emergency comprises illuminating the one or more strobe lights and providing a message on the electronic visual display.

14. The method for providing emergency message alerts of claim 12, wherein continuously monitoring comprises monitoring a television broadcast for emergency messages.

15. The method for providing emergency message alerts of claim 12, wherein continuously monitoring comprises monitoring a government emergency alert system for emergency messages.

16. The method for providing emergency message alerts of claim 12, the method further comprising:
activating the emergency alert system;
monitoring for the notification of the termination of an emergency; and,
deactivating the emergency alert

17. The method for providing emergency message alerts of claim 12, wherein the emergency message alert system further comprises:
a microphone for monitoring audio of an environment;
a camera for visually monitoring the environment; and
a speaker for addressing the environment.

18. The method for providing emergency message alerts of claim 17, the method further comprising:
analyzing the audio of the environment by the controller;
determining if an emergency has occurred;
generating an emergency alert signal; and,
transmitting the emergency alert signal to a remote location.

19. The method for providing emergency message alerts of claim 18, wherein the emergency alert signal comprises an image obtained by the camera.

20. The method for providing emergency message alerts of claim 19, wherein analyzing the audio of the environment comprises analyzing the audio to sense a gun was shot.
